(19) United States
(12) Patent Application Publication
(10) Pub. No.: US 2025/0042464 A1
(43) Pub. Date: Feb. 6, 2025

(54) STEER BY WIRE

(71) Applicant: Tesla, lnc., Austin, TX (US)

(72) Inventors: Joel Van Rooyen, San Francisco, CA (US); Mike Kessler, Los Gatos, CA (US); Jacob Federico, Austin, TX (US); Brian Dohler, Austin, TX (US); Steve Harasym, Austin, TX (US)

(21) Appl. No.: 18/717,716

(22) PCT Filed: Dec. 7, 2022
(86) PCT No.: PCT/US2022/052125

§ 371 Date: Jun. 7, 2024

Related U.S. Application Data
(60) Provisional application No. 63/265,238, filed on Dec. 10, 2021.

(51) Int. Cl. B62D 5/00; B60R 16/027; B60R 16/033; B62D 5/04

(52) U.S. Cl. CPC B62D 5/006; B60R 16/027; B60R 16/033; B62D 5/0418

(57) ABSTRACT

A vehicle steering system by wire to control the lateral motion of the vehicle is provided. The system includes a steering wheel torque feedback actuator assembly with two controllers, a front road wheel steering actuator assembly with two zonally isolated motors and controllers, two separate power assemblies, two separate vehicle communication networks in separate wiring bundle assemblies, and three private system communication networks between each node in the steering system. The redundant components are zonally isolated such that common cause of faults do not endanger the system when one or more of the components fails. The system can include differential gearbox road wheel actuator to allow absolute position of the road wheels. The system can further include a set of position sensor assemblies including two magnetic and one inductive sensor assemblies.

### CROSS-REFERENCE TO RELATED APPLICATIONS

This application claims the benefit of U.S. Provisional Application No. 63/265,238, filed Dec. 10, 2021, the entire disclosure of which is hereby incorporated by reference in its entirety.

### TECHNICAL FIELD

The present disclosure relates to a steering system for a vehicle. More particularly, the steering system can control lateral motion of the vehicle without a mechanical link to a hand wheel on the vehicle and/or include redundancy to reduce faults and avoid failures.

### BACKGROUND

A traditional steering system employs a mechanical system (e.g., rack-and-pinion, steering-box, etc.) to control the motion of a vehicle. Mechanical links are used to connect road wheels to a hand wheel. The mechanical systems may be power assisted to reduce the effort required by the system to move the road wheels, especially at low speeds. The power assist system may include oil reservoirs and oil pumps (e.g., hydraulic system) which provide oil under high pressure to the mechanical system. Thus, a traditional steering system can be complicated and susceptible to various kinds of faults and failures due to its mechanical nature and high pressure. A steer by wire system can avoid many of the faults by substituting the mechanical system with an electrical system. More specifically, mechanical links between the steering wheel and the road wheel can be substituted with electrical wires in a steer by wire system. A steer by wire system can also improve the vehicle driving experience and maneuverability by allowing innovative features and designs. For example, a steer by wire system allows flexible positioning of the hand wheel on the vehicle whereas a traditional steering system requires the hand wheel to be placed at a fixed location.

A steer by wire systems can still be susceptible to failures when electrical faults or some other kinds of faults (e.g. thermal, magnetic, or mechanical faults) happen. Prior approaches include maintaining a mechanical system as a backup to the steer by wire system. However, an extra mechanical system can be costly and add extra weight and limitations to the vehicle. There remains a need to improve a steer by wire system to further reduce faults and provide redundancies in the event of a system failure while retaining the advantages of a steer by wire system.

### SUMMARY OF THE DISCLOSURE

The disclosure relates generally to a system for controlling lateral motion of a vehicle. More specifically, the present disclosure relates to a steering system without a mechanical link to the hand wheel that provides redundancies and reduces faults.

An aspect is directed to a steer by wire system for a vehicle. The system can comprise a road wheel steering assembly configured to engage and control a first road wheel and a second road wheel. The road wheel steering assembly comprises a first road wheel actuator configured to actuate the first road wheel and the second road wheel and a second road wheel actuator configured to actuate the first road wheel and the second road wheel. The first road wheel actuator is configured to be zonally isolated from the second road wheel actuator.

The aspect above further comprises a steering feedback assembly configured to engage and control a steering wheel. The steering feedback assembly comprises a steering feedback actuator configured to actuate the steering wheel.

The aspect above further comprises a first power supply assembly and a second power supply assembly configured to provide power to the system, wherein the first power supply assembly is configured to be zonally isolated from the second power supply assembly.

The aspect above further comprises a first vehicle communication network and a second vehicle communication network configured to enable communication in the system. The first vehicle communication network is in a first wiring bundle assembly, and the second vehicle communication network is in a second wiring bundle assembly. The first wiring bundle assembly is configured to be zonally isolated from the second wiring bundle assembly.

The aspect above further comprises a first private system communication network, a second private communication network, and a third private communication network.

A variation of the aspect above is, wherein the first road wheel actuator comprises a first motor configured to provide energy to a first gearbox and a first road wheel actuator controller configured to receive information from a first one or more motor position sensors and provide output to the first motor. The first gearbox is configured to move the first road wheel and the second road wheel. The second road wheel actuator comprises a second motor configured to provide energy to a second gearbox and a second road wheel actuator controller configured to provide output to the first motor. The second gearbox is configured to move the first road wheel and the second road wheel.

A variation of the aspect above is, wherein the steering feedback actuator comprises a rotor configured to provide energy to a third gearbox. The third gearbox is configured to control the steering wheel. The variation further comprises a first feedback actuator controller configured to receive input from a third one or more motor position sensor and provide output to a first stator, wherein the first stator is connected to the rotor. The variation further comprises a second feedback actuator controller configured to receive input from a fourth one or more motor position sensor and provide output to a second stator, wherein the second stator is connected to the rotor.

A variation of the aspect above is, wherein the first stator and the second stator of the steering feedback assembly comprise fault tolerant stator windings.

A variation of the aspect above further comprises a differential gearbox configured to enable accurate positioning of the first road wheel and the second road wheel.

A variation of the aspect above is, wherein the first power supply assembly comprises a first battery providing power to a first vehicle power controller. The first vehicle power controller provides output to a first part of the system. The second power supply assembly comprises a second battery providing power to a second vehicle power controller. The second vehicle power controller provides output to a second part of the system.

A variation of the aspect above is, wherein the first battery and the second battery are high voltage batteries.

A variation of the aspect above is, wherein the first battery is a high voltage battery and the second battery is a low voltage battery.

A variation of the aspect above is, wherein the first vehicle power controller and the second vehicle power controller are intelligent vehicle power controllers.

A variation of the aspect above is, wherein the second road wheel actuator controller is configured to receive information from a second one or more motor position sensors.

A variation of the aspect above is, wherein at least one of the first road wheel actuator controller, the second road wheel actuator controller, the first feedback actuator controller, and the second feedback actuator controller comprises a first microprocessor and a second microprocessor.

A variation of the aspect above is, wherein the first microprocessor is configured to receive measured data, process the measured data, and produce a desired torque command.

A variation of the aspect above is, wherein the first microprocessor is further configured to emit a set of pulse width modulation signals, and generate a torque according to the desired torque command.

A variation of the aspect above is, wherein the first microprocessor is configured to produce the desired torque command using a first software, and generate the pulse width modulation signals using a second software.

A variation of the aspect above is, wherein the measured data comprises voltage sense, current sense, and power stage configuration and status.

A variation of the aspect above is, wherein the second microprocessor is configured to determine a torque command, estimate the actual torque produced, and determine whether the torque command and actual torque produced align with predetermined values.

A variation of the aspect above is, wherein when the second microprocessor determines that the torque command and actual torque produced do not align with the predetermine values, the second microprocessor is configured to turn off power electronics associated with the first and second microprocessors.

A variation of the aspect above is, wherein the second microprocessor is further configured to emit a message to trigger an arbitration action to ensure steering control continues on a redundant element.

A variation of the aspect above is, wherein the first road wheel actuator controller and the second road wheel actuator controller communicate continuously and bidirectionally, the first feedback actuator controller and the second feedback actuator controller communicate continuously and bidirectionally, the first road wheel actuator controller and the first feedback actuator controller communicate continuously and bidirectionally, and the second road wheel actuator controller and the second feedback actuator controller communicate continuously and bidirectionally.

A variation of the aspect above is, wherein the bidirectional communications between the first and second road wheel actuator controllers and the first and second feedback actuator controllers are routed through separate paths.

Another aspect of this disclosure includes a steer by wire system with redundancy including a road wheel steering assembly configured to engage and control a first road wheel and a second road wheel. The road wheel steering assembly comprises a first road wheel actuator configured to actuate the first road wheel and the second road wheel, and a second road wheel actuator configured to actuate the first road wheel and the second road wheel. The first road wheel actuator is configured to be zonally isolated from the second road wheel actuator. The system further includes a first power supply assembly and a second power supply assembly configured to provide power to the system, wherein the first power supply assembly is configured to be zonally isolated from the second power supply assembly. The system also includes a first vehicle communication network and a second vehicle communication network configured to enable communication in the system, wherein the first vehicle communication network is in a first wiring bundle assembly, and the second vehicle communication network is in a second wiring bundle assembly. The first wiring bundle assembly is configured to be zonally isolated from the second wiring bundle assembly.

A variation of the aspect above is, wherein the first road wheel actuator comprises a first motor configured to provide energy to a first gearbox and a first road wheel actuator controller. The first gearbox is configured to move the first road wheel and the second road wheel. The first road wheel actuator controller configured to receive information from a first one or more motor position sensors and provide output to the first motor. The second road wheel actuator comprises a second motor and a second road wheel actuator controller. The second motor configured to provide energy to a second gearbox, wherein the second gearbox is configured to move the first road wheel and the second road wheel. The second road wheel actuator controller configured to provide output to the first motor.

The aspect above further comprises a steering feedback assembly configured to engage and control a steering wheel, the steering feedback assembly comprising, a steering feedback actuator configured to actuate the steering wheel.

A variation of the aspect above is, wherein the steering feedback actuator comprises a rotor configured to provide energy to a third gearbox. The third gearbox is configured to control the steering wheel. The steering feedback actuator comprises a first feedback actuator controller configured to receive input from a third one or more motor position sensor and provide output to a first stator, wherein the first stator is connected to the rotor. The steering feedback actuator further comprises a second feedback actuator controller configured to receive input from a fourth one or more motor position sensor and provide output to a second stator, wherein the second stator is connected to the rotor.

A variation of the aspect above is, wherein the first stator and the second stator of the steering feedback assembly comprise fault tolerant stator windings.

The aspect above further comprises a differential gearbox configured to enable accurate positioning of the first road wheel and the second road wheel.

A variation of the aspect above is, wherein the first power supply assembly comprises a first battery providing power to a first vehicle power controller. The first vehicle power controller provides output to a first part of the system. The second power supply assembly comprises a second battery providing power to a second vehicle power controller, wherein the second vehicle power controller provides output to a second part of the system.

A variation of the aspect above is, wherein the second road wheel actuator controller is configured to receive information from a second one or more motor position sensors.

A variation of the aspect above is, wherein at least one of the first road wheel actuator controller, the second road wheel actuator controller, the first feedback actuator controller, and the second feedback actuator controller comprises a first microprocessor and a second microprocessor.

A variation of the aspect above is, wherein the first microprocessor is configured to receive measured data, process the measured data, and produce a desired torque command.

A variation of the aspect above is, wherein the first microprocessor is further configured to emit a set of pulse width modulation signals, and generate a torque according to the desired torque command.

A variation of the aspect above is, wherein the measured data comprises at least voltage sense, current sense, and power stage configuration and status.

A variation of the aspect above is, wherein the second microprocessor is configured to determine a torque command, estimate the actual torque produced, and determine whether the torque command and actual torque produced align with predetermined values.

A variation of the aspect above is, wherein when the second microprocessor determines that the torque command and actual torque produced do not align with the predetermine values, the second microprocessor is configured to turn off power electronics associated with the first and second microprocessors.

A variation of the aspect above is, wherein the second microprocessor is further configured to emit a message to trigger an arbitration action to ensure steering control continues on a redundant element.

A variation of the aspect above is, wherein the first road wheel actuator controller and the second road wheel actuator controller communicate continuously and bidirectionally, the first feedback actuator controller and the second feedback actuator controller communicate continuously and bidirectionally, the first road wheel actuator controller and the first feedback actuator controller communicate continuously and bidirectionally, and the second road wheel actuator controller and the second feedback actuator controller communicate continuously and bidirectionally.

A variation of the aspect above is, wherein the bidirectional communications between the first and second road wheel actuator controllers and the first and second feedback actuator controllers are routed through separate paths.

Another aspect of this disclosure is a method of controlling a steering system by wire with redundancy. The method comprises controlling a first road wheel and a second road wheel using a first road wheel actuator; controlling the first road wheel and the second road wheel using a second road wheel actuator, wherein the first road wheel actuator is zonally isolated from the second road wheel actuator; controlling a steering wheel using a steering feedback actuator; providing power to the steering system using a first power supply assembly; providing power to the steering system using a second power supply assembly, wherein the first power supply assembly is zonally isolated from the second power supply assembly; and enabling communication in the system using a first vehicle communication network and a second vehicle communication network, wherein the first vehicle communication network is configured to be zonally isolated from the second vehicle communication network.

The aspect above further comprises determining and implementing output for the first road wheel actuator to move the first road wheel and the second road wheel with the first feedback road wheel actuator controller. The output is based at least in part on information from a first one or more motor position sensors. The method further comprises determining and implementing output for the second road wheel actuator to move the first road wheel and the second road wheel with the second feedback road wheel actuator controller. The output is based at least in part on information from a second one or more motor position sensors.

The aspect above further comprises determining and implementing output for the steering feedback actuator to move the steering wheel with the first feedback actuator controller. The output is based at least in part on information from a third one or more motor position sensors. The method further comprises determining and implementing output for the steering feedback actuator to move the steering wheel with the second feedback actuator controller. The output is based at least in part on information from a fourth one or more motor position sensors.

The aspect above further comprises positioning the first road wheel and the second road wheel using a differential gearbox.

The aspect above further comprises providing power using the first power supply assembly to a first part of the system, and providing power using the second power supply assembly to a second part of the system, wherein the first part of the system is zonally isolated from the second part of the system.

The aspect above further comprises determining output for at least one of the first road wheel actuator, the second road wheel actuator, the first feedback actuator, and the second feedback actuator with a first microprocessor and a second microprocessor.

A variation of the aspect above is, wherein the first road wheel actuator controller and the second road wheel actuator controller communicate continuously and bidirectionally, the first feedback actuator controller and the second feedback actuator controller communicate continuously and bidirectionally, the first road wheel actuator controller and the first feedback actuator controller communicate continuously and bidirectionally, and the second road wheel actuator controller and the second feedback actuator controller communicate continuously and bidirectionally.

### BRIEF DESCRIPTION OF THE DRAWINGS

The present disclosure is described with reference to the accompanying drawings, in which like reference characters reference like elements, and wherein:

FIG. 1 is a diagram showing an overview of a steering system according to one embodiment of the present invention that includes a primary road wheel actuator, a secondary road wheel actuator, and a steering feedback actuator;

FIG. 2 is a block diagram illustrating exemplary mechanical and electrical connections with the primary and secondary road wheel actuators from the steering system of FIG. 1;

FIG. 3 is a block diagram illustrating exemplary mechanical and electrical connections with the steering feedback actuator from FIG. 1;

FIG. 4 is a block diagram illustrating exemplary electrical connections for two different embodiments of a fault tolerant power supply that provides zonal isolation for the steering system of FIG. 1.

FIG. 5 is a diagram showing an overview of a steering system according to another embodiment of the present invention that includes a primary road wheel actuator, a secondary road wheel actuator, and a steering feedback actuator;

FIG. 6 is a block diagram illustrating exemplary mechanical and electrical connections with the primary and secondary road wheel actuators from the steering system of FIG. 5;

FIG. 7 is a block diagram illustrating exemplary mechanical and electrical connections with the steering feedback actuator from FIG. 5:

FIG. 8 is a block diagram illustrating exemplary mechanical and electrical connections inside each of the controllers from FIG. 5.

FIG. 9 is a block diagram illustrating exemplary communication paths between the controllers and sensors from FIG. 5.

### DETAILED DESCRIPTION

Generally described, one or more aspects of the present disclosure relate to steering systems for vehicles. In certain embodiments, one or more aspects of the disclosure relates to a steering system that can be configured to control lateral motion of a vehicle without a mechanical link to the hand wheel. In other embodiments, one or more aspects of the disclosure relates to a steering system that can be configured to provide fault tolerance and redundancy.

Embodiments of the present disclosure are directed to a steering system of a vehicle that connects the road wheels to the hand wheel with an electrical system (e.g., steer by wire). In certain embodiments, the steering system does not include a mechanical system to back up the electrical system. In certain embodiments, critical components or functions of the steer by wire system are duplicated to provide a level of redundancy to the steer by wire system. For example, in certain embodiments, the steer by wire system can comprise multiple units of individual electrical components. In certain embodiments, the multiple units are configured to be zonally isolated from one another such that a common cause for an electric, thermal, magnetic, or mechanical fault of an individual component in one unit does not jeopardize the individual electrical components in a second or redundant unit. Thus, if one of the multiple units fails, the second or redundant unit can continue to maintain the operation of the steer by wire system.

More specifically, in certain embodiments, the system can comprise a steering torque feedback assembly with two controllers (one of the two can be redundant), a front road wheel steering assembly with two fault tolerant motors (one of the two can be redundant) and two controllers (one of the two can be redundant), two intelligent vehicle power controllers (one of the two can be redundant), two separate vehicle communication networks (one of the two can be redundant), and three private system communication networks (one or more of the three can be redundant). The redundancy and zonal isolation of individual components can provide fault tolerance and protect against failures with respect to not only electrical failures but also thermal, magnetic, and mechanical failures.

The system can further comprise position sensor assemblies. Individual position sensor assemblies of the system can comprise three position sensors, wherein two of the three position sensors are magnetic, and one of the three position sensors is inductive. The three-sensor architecture can allow fault detection and isolation by utilizing two-out-of-three voting on the position mechanism.

In certain embodiments, the system can include a differential gearbox road wheel actuator and a pinion angle sensor to allow for absolute positioning. In certain embodiments, the intelligent vehicle power controllers of the system comprise metal-oxide-semiconductor field-effect transistor (“MOSFET”) switches. In certain embodiments, the vehicle communication networks and private system communication networks implement the Controller Area Network (“CAN”) protocol.

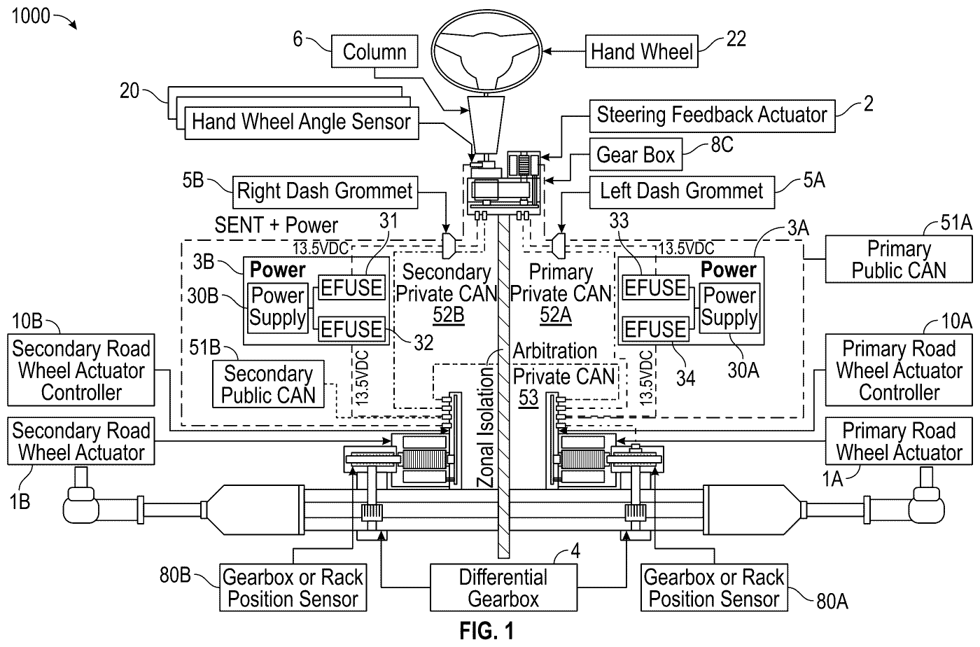

FIG. 1 is a diagram showing an overview of an exemplary steering system 1000 comprising a primary road wheel actuator 1A connected to a primary road wheel actuator controller 10A and a secondary road wheel actuator 1B connected to a secondary road wheel actuator controller 10B. In certain embodiments, the primary road wheel actuator 1A and the secondary road wheel actuator 1B both connect to a rack bar 9, which is engaged with and in control of a first front wheel and a second front wheel. The primary road wheel actuator 1A can be configured to control both of the first front wheel and the second front wheel regardless of the operational status of the secondary road wheel actuator 1B. For example, the primary road wheel actuator 1A can control both of the first front wheel and the second front wheel when the secondary road wheel actuator 1B is nonoperational or operational. The secondary road wheel actuator 1B can control both of the first front wheel and the second front wheel when the primary road wheel actuator 1A is nonoperational or operational. In certain embodiments, the secondary road wheel actuator 1B controls both of the first front wheel and the second front wheel only when the primary road wheel actuator 1A is nonoperational. The redundancy allows for isolation of system faults (e.g. electronic, thermal, magnetic, or mechanical faults).

In certain embodiments, the system 1000 can further include a differential gearbox 4 engaged with the rack bar 9 and gearbox or rack position sensors 80A and 80B engaged with and configured to provide information to the primary road wheel actuator 1A. In certain embodiments, the information allows for accurate positioning of the first front wheel and the second front wheel.

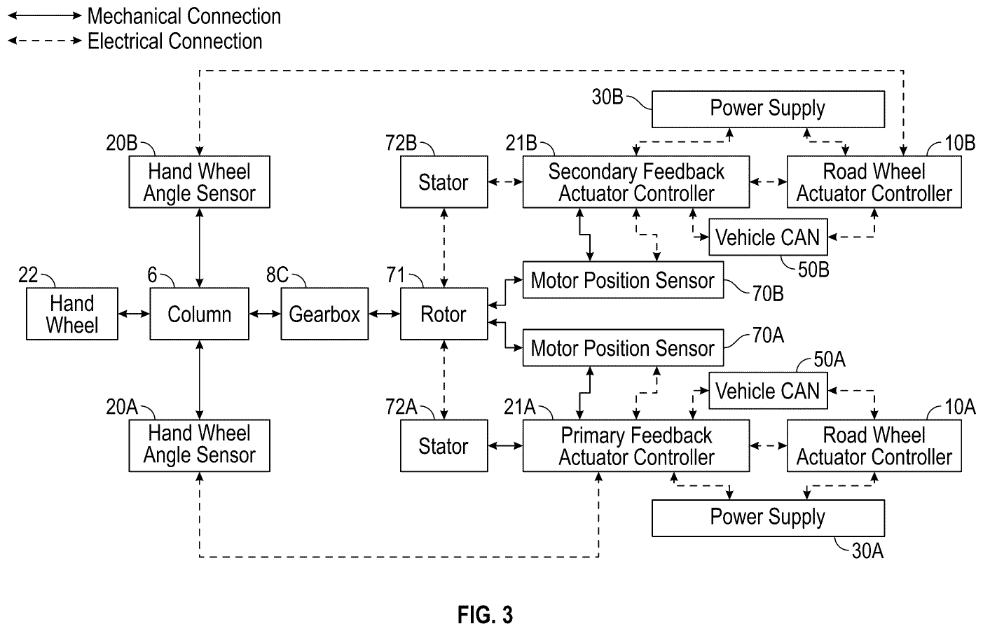

The system 1000 can further comprise a hand wheel 22, a column 6, a steering feedback actuator 2 configured to control the hand wheel 22, and one or more hand wheel angle sensors 20. The steering feedback actuator 2 can include a rotor 71 and two stators 72A and 72B (see FIG. 3). The steering feedback actuator 2 can process information from sensors and control (e.g., force feedback) the hand wheel 22 to provide a user a desired maneuver experience of the hand wheel 22 according to the road conditions. In some embodiments, the one or more hand wheel angle sensors 20 may be positioned between the column 6 and the gearbox 8C to sense rotation of the hand wheel 22. In some embodiments, the one or more hand wheel angle sensors 20 and the steering feedback actuator 2 can both be positioned on a top side of the gear box 8C, proximate the column 6.

The system 1000 can further comprise a power 3A and a power 3B. The power 3A can comprise a power supply 30A, an eFuse 33 connected to the steering feedback actuator 2, and an eFuse 34 connected to the primary road wheel actuator 1A. The power 3B can comprise a power supply 30B, an eFuse 31 connected to the steering feedback actuator 2, and an eFuse 32 connected to the secondary road wheel actuator 1B. The eFuse 31, 32, 33, and 34 can detect and react to electrical overload in the system and cut off the component connected to it to protect the rest of the system, thereby providing fault isolation.

In certain embodiments, the system 1000 can further comprise a primary public communication area network (“CAN”) 51A, a secondary public CAN 51B, a primary private CAN 52A, a secondary private CAN 52B, ad an arbitration private CAN 53. The redundant communication systems, again zonally isolated, allow communication even when part of the system fails due to electronic, thermal, magnetic, or mechanical faults.

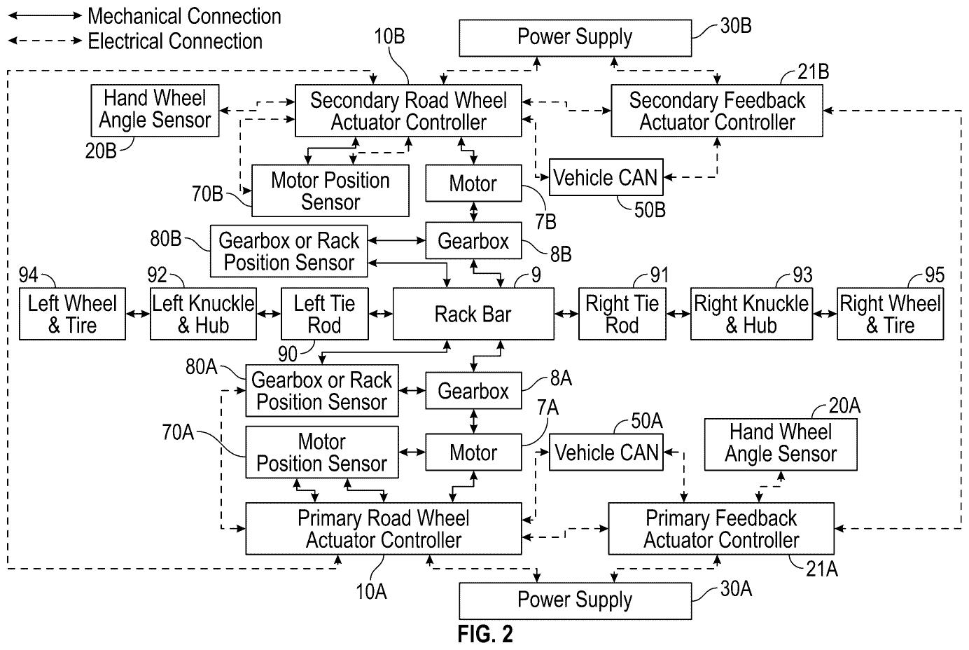

FIG. 2 is a block diagram illustrating exemplary mechanical and electrical connections between the primary and secondary road wheel actuators 1A, 1B and other elements in the system 1000 from FIG. 1. As shown in FIG. 2, blue arrows indicate electrical connections, and black arrows indicate mechanical connections. The primary road wheel actuator 1A can comprise road wheel actuator controller 10A configured to control a motor 7A, which can in turn causes a left wheel & tire 94 and a right wheel & tire 95 to move. The left wheel & tire 94 is connected to the right wheel & tire 95 through a left knuckle & hub 92, a left tie rod 90, a rack bar 9 in the middle, a right tie rod 91, and a right knuckle & hub 93. The motor 7A causes the left wheel & tire 94 and the right wheel & tire 95 to move by controlling a gearbox 8A, which can engage and move the rack bar 9.

In certain embodiments, the road wheel actuator controller 10A is in communication with a feedback actuator controller 21A through a vehicle CAN 50A. A power supply 30A provides power to both the road wheel actuator controller 10A and the feedback actuator controller 21A.

In certain embodiments, a motor position sensor 70A can be configured to connect to the motor 7A and provide information to the road wheel actuator controller 10A. In certain embodiment, a gearbox or rack position sensor 80A can be configured to connect to the rack bar 9 or the gearbox 8A and provide information to the road wheel actuator controller 10A. In certain embodiments, a hand wheel angle sensor 20A can be configured to provide information to the feedback actuator controller 21A.

The secondary road wheel actuator 1B in FIG. 2 can further comprise a redundant set of a gearbox 8B, a motor 7B, and a road wheel actuator controller 10B, each configured to operate substantially the same as described above. In certain embodiments, the road wheel actuator controller 10B is in communication with a feedback actuator controller 21B through a vehicle CAN 50B. A power supply 30B provides power to both the road wheel actuator controller 10B and the feedback actuator controller 21B.

In certain embodiments, the secondary road wheel actuator 1B can includes redundant set of sensors configured and operates substantially the same as described above, comprising a motor position sensor 70B, a gearbox or rack position sensor 80B, a hand wheel angle sensor 20B.

FIG. 3 is a block diagram illustrating exemplary mechanical and electrical connections between the steering feedback actuator 2 and other elements in the system 1000 from FIG. 2. As shown in FIG. 3, blue arrows indicate electrical connections, and black arrows indicate mechanical connections. In certain embodiments, the steering feedback actuator 2 can comprise a feedback actuator controller 21A configured to connect to a stator 72A, a rotor 71, a gearbox 8C, which is connected to the column 6 and in turn controls the steering angle of a hand wheel 22 to provide feedback to a user of the hand wheel according to conditions of the road.

In certain embodiments, a hand wheel angle sensor 20A is configured to connect to the column and provide information to the feedback actuator controller 21A. In certain embodiments, a motor position sensor 70A is configured to connect to the rotor 71 and provide information to the feedback actuator controller 21A.

FIG. 3 further discloses a redundant set of a feedback actuator controller 21B and a stator 72B that is configured and operates substantially the same as described above. In certain embodiments, a hand wheel angle sensor 20B is configured to connect to the column 6 and provide information to the feedback actuator controller 21B.

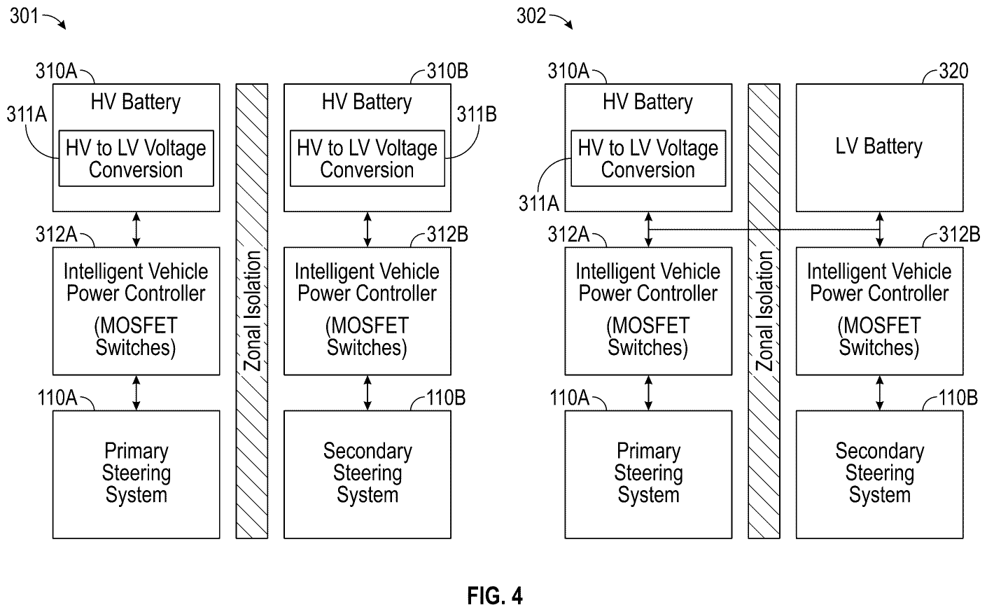

FIG. 4 is a block diagram illustrating two different embodiments of a fault tolerant power supply, a dual high voltage (“HV”) power supply 301 and a high voltage (“HV”) and low voltage (“LV”) power supply 302. As shown in FIG. 4, blue arrows indicate electrical connections. The dual HV power supply 301 can comprise a first HV battery 310A and a second HV battery 310B. In certain embodiments, the first HV power supply 310A and the second HV power supply 310B can each include one of a HV to LV voltage conversion 311A (“a step-down conversion”) and a HV to LV voltage conversion 311B.

The HV to LV voltage conversion 311A and 311B can each provides direct current (“DC”) voltage to one of an intelligent vehicle power controller 312A and an intelligent vehicle power controller 312B, wherein the two intelligent vehicle power controller 312A and 312B are separated and zonally isolated from each other. In certain embodiments, the intelligent vehicle power controllers 312A and 312B can comprise MOSFET switches.

Each of the intelligent vehicle power controllers 312A and 312B of the dual HV power supply 301 can then provide voltage and power protection to one of a primary steering system 110A and a secondary steering system 110B. In certain embodiments, the primary steering system 110A can comprise a first part or whole of the steering feedback actuator 2, the primary road wheel actuator 1A, the primary private CAN 52A, and the primary public CAN 51A as shown in FIG. 1. In certain embodiments, the secondary steering system 110B can comprise a second part or whole of the steering feedback actuator 2, the secondary road wheel actuator 1B, the secondary private CAN 52B, and the secondary public CAN 51B as shown in FIG. 1. In certain embodiments, the primary steering system 110A and the secondary steering system 110B can be capable of fault-free bi-directional current (e.g., steering reversal regenerative current).

Another embodiment of a fault tolerant power supply is the HV and LV power supply 302 shown in FIG. 4. The HV and LV power supply 302 can comprise a HV battery 310A and a LV battery 320. In some embodiments, the HV battery 310A can include a HV to LV voltage conversion 311A.

In some embodiments, each of the HV battery 310A and the LV battery 320 support one of an intelligent vehicle power controller 312A and an intelligent vehicle power controller 312B. In certain embodiments, the intelligent vehicle power controllers 312A and 312B can comprise MOSFET switches.

In some embodiments, the HV and LV power supply 302 can further comprise an electrical connection 322 linking the connection between HV Battery 310A and the intelligent vehicle power controller 312A to the connection between LV battery 320 and the intelligent vehicle power controller 312B.

In some embodiments, each of the intelligent vehicle power controllers 312A and 312B can provide voltage and power protection to one of a primary steering system 110A and a secondary steering system 110B. In certain embodiments, the primary steering system 110A and the secondary steering system 110B can be capable of fault-free bi-directional current (e.g. steering reversal regenerative current).

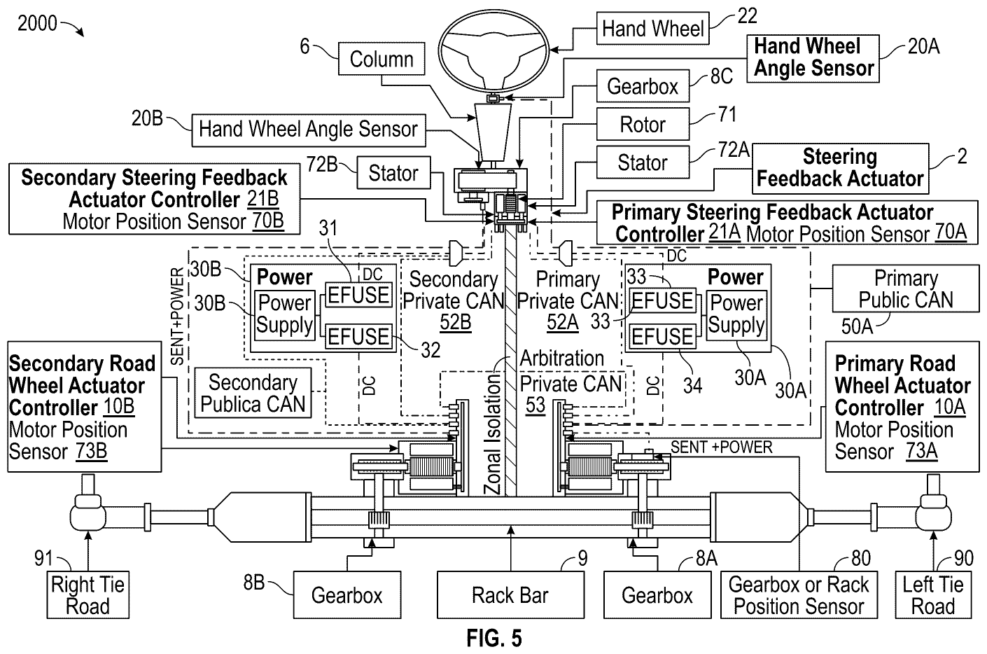

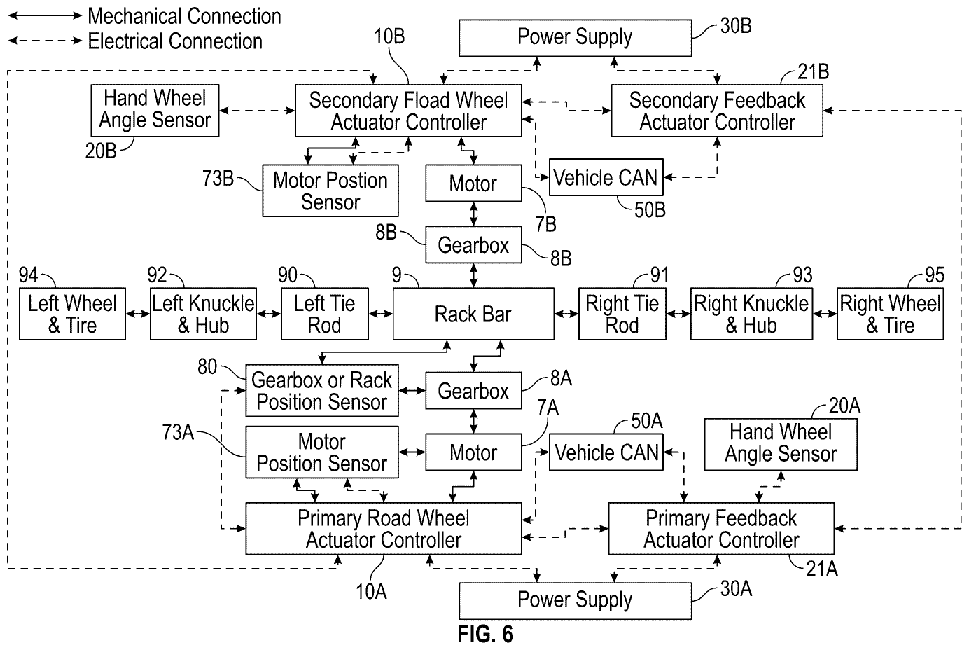

Another embodiment of a steering system according to this disclosure is shown in FIGS. 5-7. As shown in FIGS. 5 and 6, the steering system 2000 can similarly comprise a primary road wheel actuator controller 10A and a secondary road wheel actuator controller 10B, each controlling an actuator connected to the rack bar 9, which is engaged with and in control of a first front wheel and a second front wheel. However, different from the steering system 1000, in some embodiments, the steering system 2000 can have a first hand wheel angle sensor 20A positioned between the hand wheel 22 and the column 6 to better sense the rotation of the hand wheel 22. The first hand wheel angle sensor 20A proximate the hand wheel 22 can also be connected to the primary public CAN 50A. In some embodiments, the steering system 2000 can include both the second hand wheel angle sensor 20B and the steering feedback actuator 2 positioned on a bottom side of the gearbox 8C opposite the top side of the gearbox 8C. In some embodiments, the one or more hand wheel angle sensors 20 and the steering feedback actuator 2 can both be positioned on a top side of the gear box 8C, proximate the column 6.

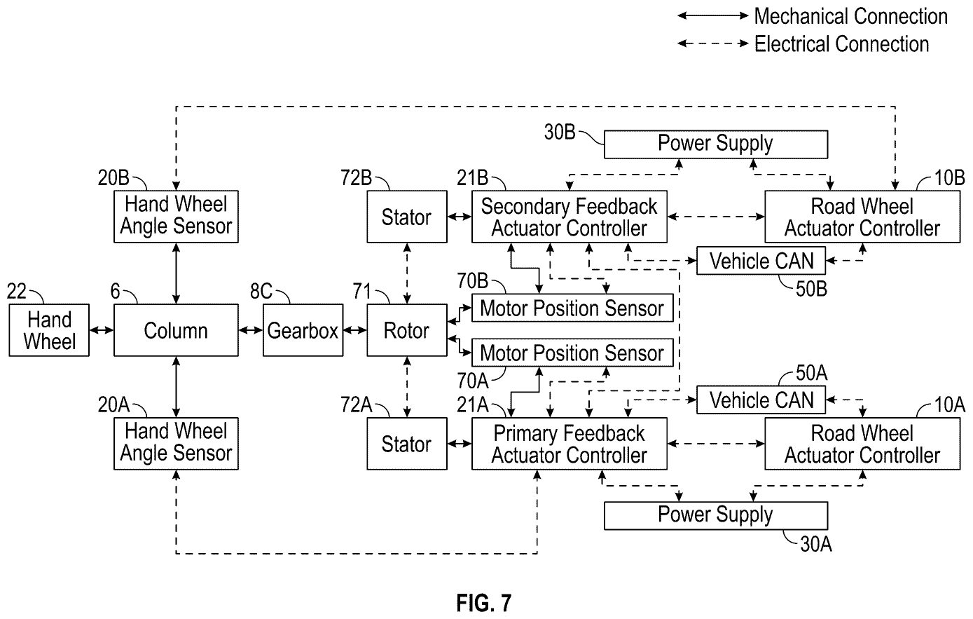

In some embodiments, the steering system 2000 can also have communication lines routed differently, for example the secondary public CAN 50B can be connected to both the secondary steering feedback actuator controller 21B and the secondary road wheel actuator controller 10B, instead of only the secondary steering feedback actuator controller 21B as in the steering system 1000. Further, in some embodiments, the steering system 2000 can include an additional electrical connection between the primary feedback actuator controller 21A and the secondary feedback actuator controller 21B as shown in FIG. 7.

In some embodiments, the steering system 2000 can include only one gearbox or rack position sensor 80 instead of two (e.g., 80A and 80B) as in the steering system 1000 because of the existing communication between the primary road wheel actuator controller 10A and the secondary road wheel actuator controller 10B as shown in FIG. 6.

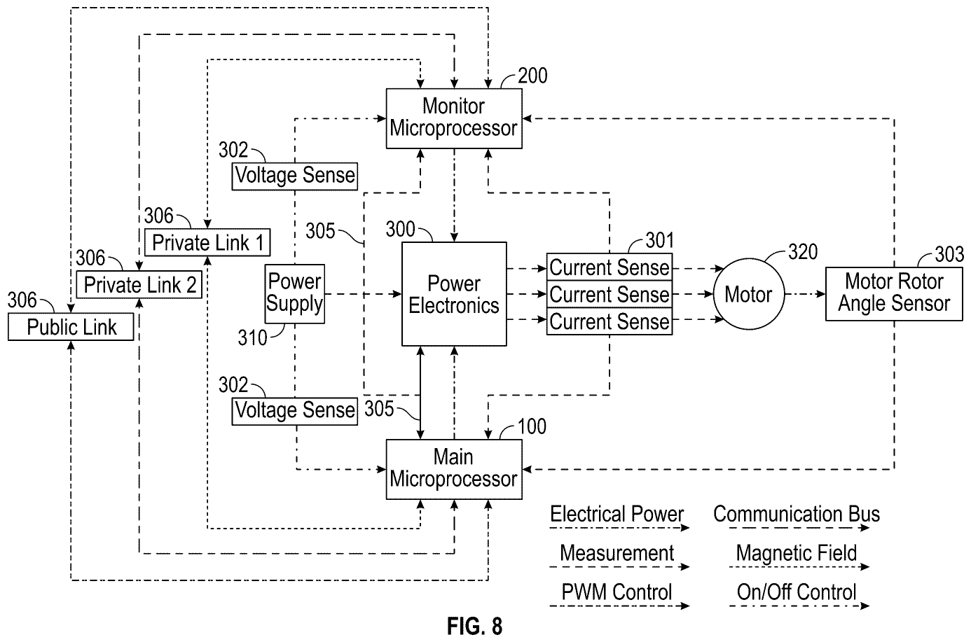

Another aspect of this disclosure includes the mechanical and electrical connections inside each controller as shown in FIG. 8. Inside each of the controller blocks (e.g., the primary and secondary road wheel actuator controllers 10A and 10B, and the primary and secondary sheering feedback actuator controllers 21A and 21B of steering system 2000), there can exists two microprocessors, each running a different software. In certain embodiments, the two microprocessors can include a main microprocessor 100 and a monitor microprocessor 200, both connected to power electronics 300. The power electronics 300 can be powered by power supply 310.

The main microprocessor 100 can be configured to take data (e.g., vehicle, user inputs, and/or signals) from adjacent controllers, public bus data, and on-board sensors through communication lines 306 (e.g., private links 1, 2, and the public link) as shown in FIG. 8. The main microprocessor 100 can be configured to then process the received data, and produce a desired torque command using a torque path software/algorithm. In some embodiments, electronic elements on a circuit board of each controller may be configured to provide the main microprocessor 100 with one or more measurements of the controller system and process the input measurements. In some embodiments, the measurements can include voltage sense 301 of the power supply 310, current sense 302 between the power electronics 300 and a motor 320, and motor rotor angle from a motor rotor angle sensor 303. In some embodiments, the measurements can also include power stage configuration and status 305. While processing the input measurements, in some embodiments, the main microprocessor 100 can be configured to emit a set of Pulse Width Modulation (PWM) signals which generate rapid switching in the power electronics that control voltage and current applied motor windings to generate torque to match the torque command generated by the torque path software. The main microprocessor 100 can employ a motor control software to generate PWMs.

The monitor microprocessor 200 can be configured to cross-check the rationality of all actions taken by the main microprocessor 100 in order to monitor the rationality of the torque path software in the main microprocessor 100. In some embodiments, the monitor microprocessor 200 can be connected to same communication buses as that of the main microprocessor 100. In some embodiments, the monitor microprocessor 200 can also employ a duplicate of the motor control software running in the main microprocessor 100, which uses the same data such as the voltage sense 301, the current sense 302, and the power stage configuration and status, to estimate the actual torque produced. For example, if the calculated torque command and estimated torque produced do not align with behavior that guarantees the safe operation of the system, the monitor microprocessor 200 can actuate a switching element which will disable the power stage 305, rendering the power electronics 300 inert and removes applied power to the motor 320. The monitor microprocessor 200 will also emit messages on communication buses which trigger arbitration action on power electronics of other controller systems to ensure that steering control continues on redundant elements.

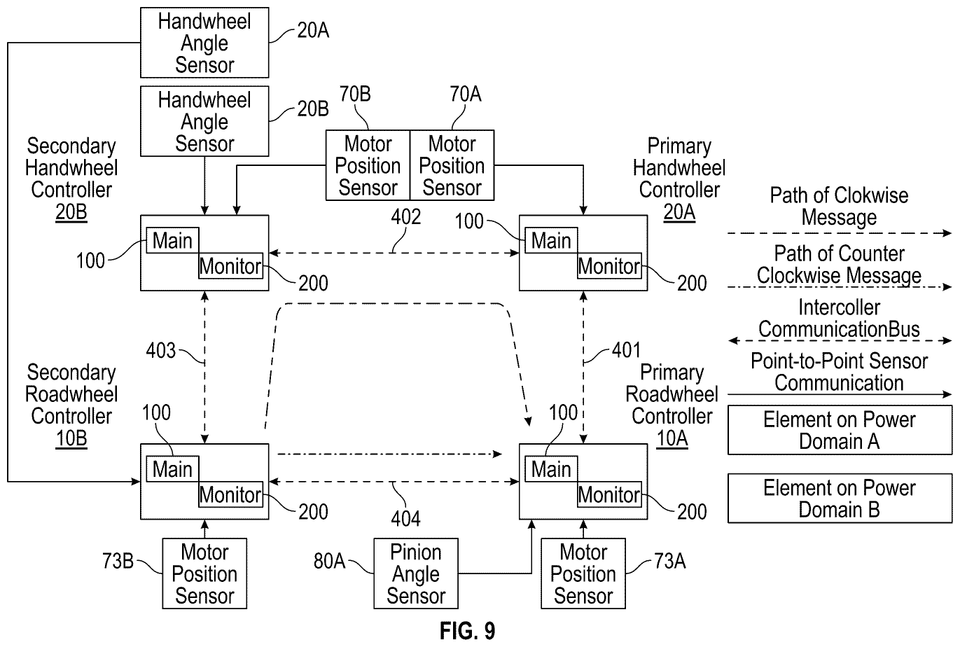

In order to achieve continuous lateral control of the vehicle and a smooth transition between possible backup states, in some embodiments, the steering system 2000 can be configured to maintain continuous bidirectional communications 401, 402, 403, and 404 between the controllers (e.g., the primary and secondary road wheel actuator controllers 10A and 10B, and the primary and secondary sheering feedback actuator controllers 21A and 21B) as shown in FIG. 9 in order to execute arbitration processes. The arbitration processes can be configured to make decisions including which controller should be currently in charge of translating the handwheel angle into a desired roadwheel angle, which controller should be in charge of generating torque to meet the desired roadwheel angle, and which controller should be in charge of calculating and generating feedback torque on the handwheel 22 to give a desirable and safe driving experience. All communications 401, 402, 403, and 404 in the arbitration processes can be routed redundantly through two separate paths, such that each controller receives the status and intentions of another controller on two separate communication buses.

In some embodiments, as shown in FIG. 9, there is a set of handwheel controller, roadwheel controller, handwheel motor position sensor, motor position sensor, and pinion angle sensor on each of a power domain A and a power domain B (e.g., each power domain powered by a separate battery). Additionally, rationality of each main microprocessor in the controller is expressed by the corresponding monitor microprocessor in that controller. Therefore, if a monitor processor flags irrationality, or if the communication from either direction mismatches or otherwise indicates a malfunction which might prevent safe operation, the remaining elements can respond to remove the irrational element from the steering system 2000 and reallocate responsibilities to maintain control of the vehicle's lateral motion.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed glove box actuation assembly. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

1. A steer by wire system with redundancy comprising:
a road wheel steering assembly configured to engage and control a first road wheel and a second road wheel, the road wheel steering assembly comprising,
a first road wheel actuator configured to actuate the first wheel and the second wheel, a second road wheel actuator configured to actuate the first wheel and the second wheel,
wherein the first road wheel actuator is configured to be zonally isolated from the second road wheel actuator; and
a steering feedback assembly configured to engage and control a steering wheel, the steering feedback assembly comprising,
a steering feedback actuator configured to actuate the steering wheel.

2. The system of claim 1, further comprising a first power supply assembly and a second power supply assembly configured to provide power to the system, wherein the first power supply assembly is configured to be zonally isolated from the second power supply assembly.

3. The system of claim 1, further comprising a first vehicle communication network and a second vehicle communication network configured to enable communication in the system, wherein the first vehicle communication network is in a first wiring bundle assembly, the second vehicle communication network is in a second wiring bundle assembly, and the first wiring bundle assembly is configured to be zonally isolated from the second wiring bundle assembly.

4. The system of claim 1, further comprising a first private system communication network, a second private communication network, and a third private communication network.

5. The system of claim 1, wherein the first road wheel actuator comprises
a first motor configured to provide energy to a first gearbox, wherein the first gearbox is configured to move the first road wheel and the second road wheel; and
a first road wheel actuator controller configured to receive information from a first one or more motor position sensors and provide output to the first motor; and
wherein the second road wheel actuator comprises:
a second motor configured to provide energy to a second gearbox, wherein the second gearbox is configured to move the first road wheel and the second road wheel; and
a second road wheel actuator controller configured to provide output to the first motor.

6. The system of claim 5, wherein the steering feedback actuator comprises:
a rotor configured to provide energy to a third gearbox, wherein the third gearbox is configured to control the steering wheel;
a first feedback actuator controller configured to receive input from a third one or more motor position sensor and provide output to a first stator, wherein the first stator is connected to the rotor; and
a second feedback actuator controller configured to receive input from a fourth one or more motor position sensor and provide output to a second stator, wherein the second stator is connected to the rotor.

7. The system of claim 6, wherein the first stator and the second stator of the steering feedback assembly comprise fault tolerant stator windings.

8. The system of claim 1, further comprising a differential gearbox configured to enable accurate positioning of the first road wheel and the second road wheel.

9. The system of claim 2, wherein the first power supply assembly comprises a first battery providing power to a first vehicle power controller, wherein the first vehicle power controller provide output to a first part of the system,
and wherein the second power supply assembly comprises a second battery providing power to a second vehicle power controller, wherein the second vehicle power controller provide output to a second part of the system.

10. The system of claim 9, wherein the first battery and the second battery are high voltage batteries.

11. The system of claim 9, wherein the first battery is a high voltage battery and the second battery is a low voltage battery.

12. The system of claim 9, wherein the first vehicle power controller and the second vehicle power controller are intelligent vehicle power controllers.

13. The system of claim 5, wherein the second road wheel actuator controller is configured to receive information from a second one or more motor position sensors.

14. The system of claim 6, wherein at least one of the first road wheel actuator controller, the second road wheel actuator controller, the first feedback actuator controller, and the second feedback actuator controller comprises a first microprocessor and a second microprocessor.

15. The system of claim 14, wherein the first microprocessor is configured to receive measured data, process the measured data, and produce a desired torque command.

16. The system of claim 15, wherein the first microprocessor is further configured to emit a set of pulse width modulation signals, and generate a torque according to the desired torque command.

17. The system of claim 16, wherein the first microprocessor is configured to produce the desired torque command using a first software, and generate the pulse width modulation signals using a second software.

18. The system of claim 15, wherein the measured data comprises voltage sense, current sense, and power stage configuration and status.

19-23. (canceled)

24. A steer by wire system with redundancy, comprising:
a road wheel steering assembly configured to engage and control a first road wheel and a second road wheel, the road wheel steering assembly comprising:
a first road wheel actuator configured to actuate the first road wheel and the second road wheel; and
a second road wheel actuator configured to actuate the first road wheel and the second road wheel,
wherein the first road wheel actuator is configured to be zonally isolated from the second road wheel actuator.

25-42. (canceled)

43. A method of controlling a steering system by wire with redundancy, comprising:
controlling a first road wheel and a second road wheel using a first road wheel actuator;
controlling the first road wheel and the second road wheel using a second road wheel actuator, wherein the first road wheel actuator is zonally isolated from the second road wheel actuator; and
controlling a steering wheel using a steering feedback actuator.

44-51.
